(19) United States
(12) Patent Application Publication
(10) Pub. No.: US 2026/0310898 A1
(43) Pub. Date: Oct. 8, 2026

(54) LARGE LANGUAGE MODEL (LLM) ENTITY AND RELATIONSHIP EXTRACTION FOR FINE-TUNING LLMS

(71) Applicant: Raytheon Company, Arlington, VA (US)

(72) Inventors: Darrell L. Young, Quinlan, TX (US); Christine R. Nezda, Richardson, TX (US); Hninn O. Khin, Tysons, VA (US)

(21) Appl. No.: 19/169,874

(22) Filed: Apr. 3, 2025

(51) Int. Cl. G06F 40/30; G06F 16/3329; G06F 40/284

(52) U.S. Cl. CPC G06F 40/30; G06F 16/3329; G06F 40/284

(57) ABSTRACT

A method for fine-tuning a large language model that operates in conjunction with retrieval augmentation generation and in-context learning includes providing embeddings of training samples to the large language model. The method also includes generating outputs using the large language model based on the embeddings of the training samples, where the large language model generates the outputs by extracting entities or relationships from unstructured text. The unstructured text is provided as a result of the retrieval augmentation generation and the in-context learning. The method further includes determining a loss associated with the large language model using the outputs and modifying the large language model using the loss. The loss is based on a loss term associated with hallucination mitigation, and the loss term associated with hallucination mitigation is modulated during the fine-tuning of the large language model as a result of usage of terms that are hallucination-prone in the outputs.

### TECHNICAL FIELD

This disclosure relates generally to machine learning systems and processes. More specifically, this disclosure relates to large language model (LLM) entity and relationship extraction for fine-tuning LLMs.

### BACKGROUND

Numerous organizations have documents containing unstructured text, meaning text that does not follow a predefined format. Examples of documents containing unstructured text can include status reports, emails, chat sessions, user manuals, concepts of operations (CONOPS), requirements documents, gate packages, trade study results, specification sheets, brochures, test results, test plans, architecture documents, deficiency reports, contracts, proposals, bills of materials (BOMs), plans, procedures, and policies. As a result, documents containing unstructured text may have a wealth of information, but that information can be locked into unstructured data formats that are not machine-accessible.

### SUMMARY

This disclosure relates to large language model (LLM) entity and relationship extraction for fine-tuning LLMs.

In a first embodiment, a method for fine-tuning a large language model that operates in conjunction with retrieval augmentation generation and in-context learning includes providing embeddings of training samples to the large language model. The method also includes generating outputs using the large language model based on the embeddings of the training samples, where the large language model generates the outputs by extracting entities or relationships from unstructured text. The unstructured text is provided as a result of the retrieval augmentation generation and the in-context learning. The method further includes determining a loss associated with the large language model using the outputs and modifying the large language model using the loss. The loss is based on a loss term associated with hallucination mitigation. The loss term associated with hallucination mitigation is modulated during the fine-tuning of the large language model as a result of usage of terms that are hallucination-prone in the outputs. A non-transitory machine-readable medium may include instructions that when executed cause at least one processor to perform the method of the first embodiment.

In a second embodiment, an apparatus for fine-tuning a large language model that operates in conjunction with retrieval augmentation generation and in-context learning includes at least one processing device. The at least one processing device is configured to provide embeddings of training samples to the large language model and generate outputs using the large language model based on the embeddings of the training samples. The large language model is configured to generate the outputs by extracting entities or relationships from unstructured text, and the unstructured text is based on the retrieval augmentation generation and the in-context learning. The at least one processing device is also configured to determine a loss associated with the large language model using the outputs and modify the large language model using the loss. The loss is based on a loss term associated with hallucination mitigation, and the at least one processing device is configured to modulate the loss term associated with hallucination mitigation during the fine-tuning of the large language model as a result of usage of terms that are hallucination-prone in the outputs.

Any single one or any combination of the following features may be used with the first or second embodiment. Prior to providing the embeddings of the training samples to the large language model, the terms that are hallucination-prone may be identified based on interactions with the large language model using the terms. The retrieval augmentation generation may provide a subset of information extracted from the unstructured text for each training sample to the large language model. The in-context learning may provide examples of successful entity and relationship extractions from the unstructured text. The in-context learning may be trained using synthetic data generation that creates synthetic training examples of successful entity and relationship extractions based on the unstructured text. The loss may discourage hallucinations by the large language model and encourage proper grounding of the outputs generated by the large language model. The grounding may be provided by retrieval-based grounding that determines whether each response from the large language model is valid based on the associated subset of information extracted from the unstructured text. The retrieval augmentation generation, the in-context learning, and the retrieval-based grounding may be performed using related data associated with the unstructured text, and the related data may provide context for entity or relationship extraction. The embeddings of the training samples may be generated, and the embeddings may represent a domain-specific tokenization of the training samples. The loss associated with the large language model may be determined using a loss function defined as:

$${ℒ}_{custom} = \frac{1}{N} {\sum }_{i = 1}^{N} [ {λ}_{1} \cdot {ℒ}_{cosine} ( {G}_{i} , {R}_{i} ) + {λ}_{2} \cdot {ℒ}_{vocab} ( {G}_{i} ) + {λ}_{3} ( {h}_{t} ) \cdot {ℒ}_{hallucination} ( {G}_{i} ) + {λ}_{4} \cdot {ℒ}_{RAG} ( {G}_{i} , {D}_{i} ) + {λ}_{5} \cdot {ℒ}_{synthetic} ( {G}_{i} , {S}_{i} ) ]$$

where [symbol] _{custom} represents the loss associated with the large language model; N represents a number of the training samples; Gᵢ represents a response generated by the large language model for a training input i; Rᵢ represents a reference response for the training input i; Dᵢ represents a subset of information retrieved from the unstructured text for the training input i (the subset of information associated with the retrieval augmentation generation); Sᵢ represents a synthetic training example generated for the training input i (the synthetic training example associated with the in-context learning); hₜ represents a hallucination penalty for a term t identified as being hallucination-prone; [symbol] _{cosine} represents a loss term associated with semantic similarity between the generated response Gᵢ and the reference response Rᵢ; [symbol] _{vocab} represents a loss term associated with correct usage of domain-specific terminology; [symbol] _{hallucination} represents the loss term associated with hallucination mitigation and penalizes responses from the large language model that include the terms that are hallucination-prone; [symbol] _{RlAG} represents a loss term associated with the retrieval augmentation generation; [symbol] _{synthetic} represents a loss term associated with the in-context learning; and λ₁, λ₂, λ₃, λ₄, and λ₅ represent weights.

In a third embodiment, a method for using a fine-tuned large language model that operates in conjunction with retrieval augmentation generation and in-context learning includes obtaining a user input and generating an embedding of the user input. The method also includes providing the embedding of the user input and a subset of information extracted from unstructured text to the large language model. The subset of information extracted from the unstructured text is provided as a result of the retrieval augmentation generation and the in-context learning. The method further includes generating an output using the large language model, where the large language model generates the output by extracting one or more entities or one or more relationships from the subset of information extracted from the unstructured text. The large language model is trained using a loss that is based on a loss term associated with hallucination mitigation. The loss term associated with hallucination mitigation is modulated during fine-tuning of the large language model as a result of usage of terms that are hallucination-prone in outputs generated by the large language model based on training samples. An apparatus may include at least one processing device configured to perform the method of the third embodiment. A non-transitory machine-readable medium may include instructions that when executed cause at least one processor to perform the method of the third embodiment.

Any single one or any combination of the following features may be used with the third embodiment. The embedding of the user input may represent a domain-specific tokenization of the user input. The retrieval augmentation generation may provide the subset of information extracted from the unstructured text for the user input to the large language model. The in-context learning may provide examples of successful entity and relationship extractions from the unstructured text. The in-context learning may be trained using synthetic data generation that creates synthetic training examples of successful entity and relationship extractions based on the unstructured text. Retrieval-based grounding that determines whether the response from the large language model is valid may be performed based on the subset of information extracted from the unstructured text. The loss may discourage hallucinations by the large language model and encourage proper grounding. The retrieval augmentation generation, the in-context learning, and the retrieval-based grounding may be performed using related data associated with the unstructured text, and the related data may provide context for entity or relationship extraction. The loss associated with the large language model may be determined using a loss function defined as:

$${ℒ}_{custom} = \frac{1}{N} {\sum }_{i = 1}^{N} [ {λ}_{1} \cdot {ℒ}_{cosine} ( {G}_{i} , {R}_{i} ) + {λ}_{2} \cdot {ℒ}_{vocab} ( {G}_{i} ) + {λ}_{3} ( {h}_{t} ) \cdot {ℒ}_{hallucination} ( {G}_{i} ) + {λ}_{4} \cdot {ℒ}_{RAG} ( {G}_{i} , {D}_{i} ) + {λ}_{5} \cdot {ℒ}_{synthetic} ( {G}_{i} , {S}_{i} ) ]$$

where [symbol] _{custom} represents the loss associated with the large language model; N represents a number of the training samples; Gᵢ represents a response generated by the large language model for a training input i; Rᵢ represents a reference response for the training input i; Dᵢ represents a subset of information retrieved from the unstructured text for the training input i (the subset of information associated with the retrieval augmentation generation); Sᵢ represents a synthetic training example generated for the training input i (the synthetic training example associated with the in-context learning); hₜ represents a hallucination penalty for a term t identified as being hallucination-prone; [symbol] _{cosine} represents a loss term associated with semantic similarity between the generated response Gᵢ and the reference response Rᵢ; [symbol] _{vocab} represents a loss term associated with correct usage of domain-specific terminology; [symbol] _{hallucination} represents the loss term associated with hallucination mitigation and penalizes responses from the large language model that include the terms that are hallucination-prone; [symbol] _{RAG} represents a loss term associated with the retrieval augmentation generation; [symbol] _{synthetic} represents a loss term associated with the in-context learning; and λ₁, λ₂, λ₃, λ₄, and λ₅ represent weights.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example system supporting large language model (LLM) entity and relationship extraction for fine-tuning LLMs according to this disclosure;

FIG. 2 illustrates an example device supporting LLM entity and relationship extraction for fine-tuning LLMs according to this disclosure;

FIG. 3 illustrates an example architecture supporting LLM entity and relationship extraction for fine-tuning LLMs according to this disclosure;

FIG. 4 illustrates an example method for fine-tuning a large language model that operates in conjunction with retrieval augmentation generation and in-context learning according to this disclosure; and

FIG. 5 illustrates an example method for using a fine-tuned large language model that operates in conjunction with retrieval augmentation generation and in-context learning according to this disclosure.

### DETAILED DESCRIPTION

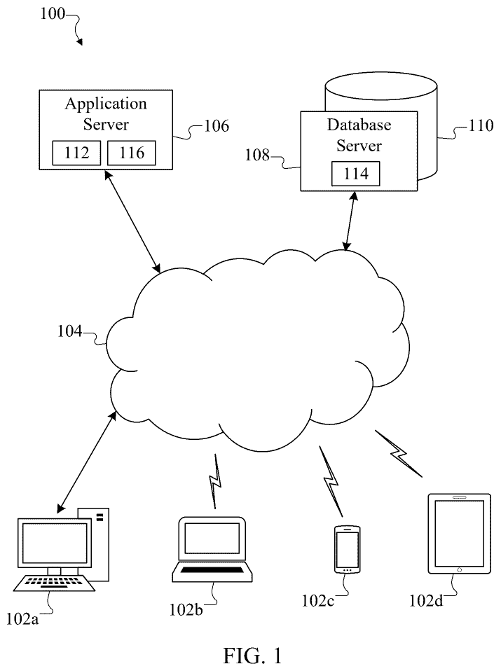

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, numerous organizations have documents containing unstructured text, meaning text that does not follow a predefined format. Examples of documents containing unstructured text can include status reports, emails, chat sessions, user manuals, concepts of operations (CONOPS), requirements documents, gate packages, trade study results, specification sheets, brochures, test results, test plans, architecture documents, deficiency reports, contracts, proposals, bills of materials (BOMs), plans, procedures, and policies. Unstructured text cannot be accessed programmatically like data in a database. As a result, documents containing unstructured text may have a wealth of information, but that information can be locked into unstructured data formats that are not machine-accessible.

Natural language processing (NLP) techniques may be effective for organizing information, constructing knowledge graphs, aiding information retrieval, and supporting decision-making processes. However, NLP techniques are often specialized and have less generalization ability compared to large language models (LLMs). However, even large language models often need to be specialized since general-purpose large language models do not function well using domain-specific terms and concepts. Fine-tuning can be performed to adapt language models (large or otherwise) for use in specialized domains, but techniques for fine-tuning can suffer from various drawbacks. For instance, techniques for fine-tuning large language models may be slow, require large amounts of training data, and/or require large amounts of processing and memory resources.

This disclosure provides various techniques related to LLM entity and relationship extraction for fine-tuning of large language models. As described in more detail below, large language models can be trained to effectively detect and extract entities and relationships between entities in unstructured text. While many large language models can extract entities and relationships, many applications (such as those within specific organizations or in specific industries) can involve specialized terms and concepts with which the large language models are not familiar. In many cases, large language models faced with unfamiliar terms and concepts resort to hallucination, which is a known problem with many large language models. The described techniques can be used to fine-tune large language models to enable the large language models to understand domain-specific terms and concepts. The described techniques can also assist large language models in recognizing unfamiliar terms and concepts, and the described techniques can ensure that outputs from large language models match expected results (which is referred to as grounding).

In this way, the described techniques provide large language models with the ability to access and use unstructured text when performing various operations. Moreover, the described techniques can be used to extend the capabilities of large language models to offer improved entity and relationship extraction (compared to conventional NPL techniques) due to the broad generalization ability of large language models. In addition, grounding and other mechanisms can be used to help reduce or avoid hallucinations.

FIG. 1 illustrates an example system 100 supporting LLM entity and relationship extraction for fine-tuning LLMs according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and the network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100, such as via wired or wireless connections. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. In some cases, the application server 106 supports the execution of at least one application 112 that can process unstructured text 114 using one or more large language models 116. For example, the application server 106 may perform the techniques described below to perform entity and relationship extraction for fine-tuning of the one or more large language models 116. The unstructured text 114 can represent text or information in any suitable format, including the various types of unstructured text described above. The one or more large language models 116 can represent any suitable language model(s) used to process unstructured text 114, such as one or more large language models that generate answers to users' queries based on the unstructured text 114.

The database server 108 operates to store and facilitate retrieval of various information used, generated, or collected by the application server 106 and the user devices 102a-102d in the database 110. For example, the database server 108 may store various information in relational database tables or other data structures in the database 110. In some embodiments, the database 110 can be used to store and facilitate retrieval of information used by the application server 106, such as the unstructured text 114. Note that the database server 108 may also be used within the application server 106 to store information, in which case the application server 106 may store the information itself.

As described below, the one or more large language models 116 can be fined-tuned to perform entity and relationship extraction. Entity and relationship extraction is often an important or useful task during natural language processing tasks or other tasks. Entity and relationship extraction generally involves identifying and classifying entities (such as names of people, organizations, locations, etc.) and relationships between the entities within text (such as the unstructured text 114). Entity recognition generally involves identifying and categorizing entities in text, and these entities can often represent proper nouns (like names of persons or organizations), locations, dates, or other concepts depending on the domain. Relationship identification can be used to identify relationships between these entities, which often involves understanding how the entities within the text are connected. Common relationships may include “works for” (Person-Organization), “located in” (Organization-Location), or “founded by” (Organization-Person). The one or more large language models 116 may be fine-tuned as described below in order to perform entity and relationship extraction based on user inputs, and the resulting entities and/or relationships can be used to generate responses to those user inputs.

Various challenges with entity and relationship extraction can include ambiguities in the entities and relationships (which can be context-dependent), variability (which means the same relationship can be expressed in multiple ways in natural language), and scalability (which means extracting relationships from large datasets may need efficient and scalable algorithms). The various techniques described below can help to overcome these or other types of issues. This type of functionality may find use in a large number of applications. Example applications can include information retrieval systems, knowledge graph construction systems, and question-answering (QA) systems. For example, in knowledge graph construction, entity and relationship extraction helps in automatically populating a graph with nodes (entities) and edges (relationships).

Although FIG. 1 illustrates one example of a system 100 supporting LLM entity and relationship extraction for fine-tuning LLMs, various changes may be made to FIG. 1. For example, the system 100 may include any suitable number of user devices 102a-102d, networks 104, application servers 106, database servers 108, databases 110, applications 112, and large language models 116 and any suitable amount of unstructured text 114. Also, these components may be located in any suitable locations and might be distributed over a large area. In addition, while FIG. 1 illustrates one example operational environment in which LLM entity and relationship extraction for fine-tuning LLMs may be used, this functionality may be used in any other suitable system.

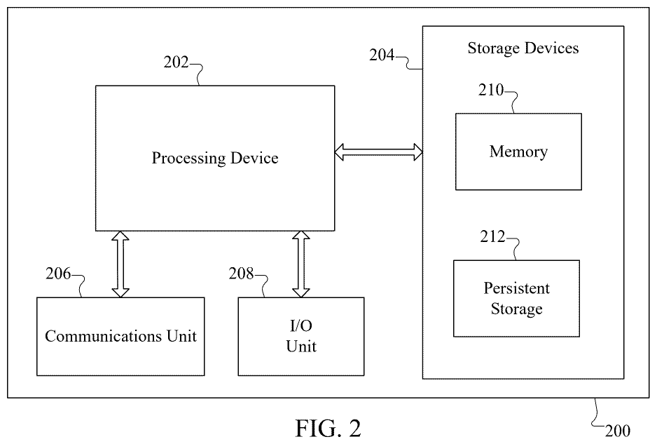

FIG. 2 illustrates an example device 200 supporting LLM entity and relationship extraction for fine-tuning LLMs according to this disclosure. One or more instances of the device 200 may, for example, be used to at least partially implement the functionality of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), graphics processing units (GPUs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device 200 does not require local I/O, such as when the device 200 represents a server or other device that can be accessed remotely.

In some embodiments, instructions can be executed by the processing device 202 in order to implement the functionality of the one or more applications 112. For example, the processing device 202 may execute instructions that cause the processing device 202 to process unstructured text 114 using one or more large language models 116. As a particular example, the processing device 202 may execute instructions that cause the processing device 202 to perform entity and relationship extraction for fine-tuning of the one or more large language models 116 as described below.

Although FIG. 2 illustrates one example of a device 200 supporting LLM entity and relationship extraction for fine-tuning LLMs, various changes may be made to FIG. 2. For example, computing and communication devices and systems come in a wide variety of configurations, and FIG. 2 does not limit this disclosure to any particular computing or communication device or system.

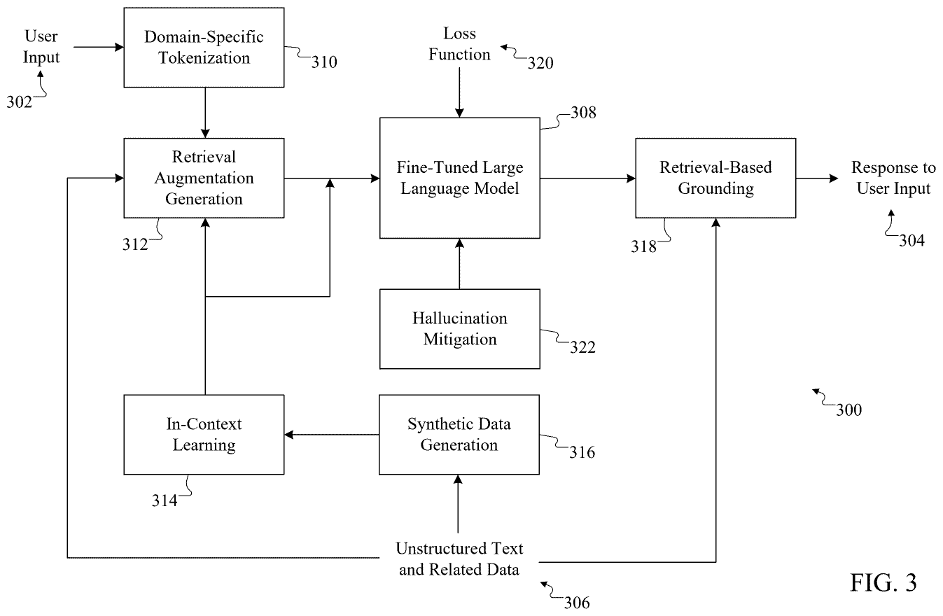

FIG. 3 illustrates an example architecture 300 supporting LLM entity and relationship extraction for fine-tuning LLMs according to this disclosure. For ease of explanation, the architecture 300 shown in FIG. 3 is described as being implemented using the application server 106 in the system 100 shown in FIG. 1, where the application server 106 may be implemented using one or more instances of the device 200 shown in FIG. 2. However, the architecture 300 may be implemented using any other suitable device(s) and in any other suitable system(s).

As shown in FIG. 3, the architecture 300 generally operates to receive user inputs 302 and generate responses 304 to the user inputs 302. Each user input 302 can represent a query or request provided by a user, such as via a user device 102a-102d. In many cases, a user input 302 can represent a natural language input, such as a query or request typed or spoken by a user and captured using a user device 102a-102d. Each response 304 can represent an answer or other suitable response to a user input 302. In many cases, a response 304 can represent a natural language output, such as an answer or other response to a query or request expressed in natural language.

The information contained in each response 304 can be determined using unstructured text and related data 306. The unstructured text and related data 306 can include the unstructured text 114, which may have any or all of the various forms mentioned above or other or additional forms. The unstructured text and related data 306 can also include additional information related to the unstructured text 114. For example, the related data may include one or more ontologies, database schemas, data dictionaries, software listings, directory structures, build files, dependency lists, or package lists. In general, the related data can represent any suitable information that can be used as context for entity and relationship extraction from the unstructured text 114.

In this example, each user input 302 (or a processed version thereof) is provided to a fine-tuned large language model 308, which may represent a large language model 116 described above. The large language model 308 represents a transformer-based or other language model that can process information in order to generate a predicted output (such as in natural language) that is estimated to represent a suitable response to each user input 302. The large language model 308 can also be fine-tuned using other components of the architecture 300 for use within at least one specialized domain. A specialized domain can represent an industry or other user space associated with specialized acronyms or other specialized terms and concepts for which the large language model 308 may not have been trained to recognize. The large language model 308 can represent any suitable language model for use in generating responses 304 to user inputs 302 based on unstructured text and related data 306.

The architecture 300 includes various components that support the use of the large language model 308 within the specialized domain(s). In this example, the architecture 300 includes a domain-specific tokenization (DST) function 310, which generally operates to produce tokens representing the user inputs 302. For instance, the domain-specific tokenization function 310 can generate embeddings, such as embedding vectors, which represent characters, words, phrases, sentences, and/or other portions of the user inputs 302. The domain-specific tokenization function 310 can also be trained to recognize specialized acronyms or other terms and concepts, such as by learning to generate embeddings for a domain-specific glossary. In some cases, these specialized terms and concepts may be unique to a specific organization using the architecture 300 and/or unique to a specific industry in which that organization operates. The effect of this is that the domain-specific tokenization function 310 has the ability to create domain-specific tokens, such as can be used for encoding specialized knowledge. The domain-specific tokenization function 310 includes any suitable logic configured to generate tokens representing user inputs 302, such as a tokenizer that has been trained to recognize tokens in the user inputs 302 and the unstructured text and related data 306.

Because the unstructured text and related data 306 may include a very large number of documents or otherwise include a very large amount of information, it may not be practical, desirable, or even possible for the large language model 308 to simply generate a response 304 to a user input 302 based on all of the unstructured text and related data 306 that might be available. In those cases, a retrieval augmentation generation (RAG) function 312 can be used to process each user input 302 and extract a subset of information from the unstructured text and related data 306 that appears relevant to that user input 302. For example, the retrieval augmentation generation function 312 may use measurements of similarity to identify specific documents or other subset of information within the unstructured text and related data 306 that appears most similar to a user input 302. Any suitable measure of similarity may be used here, such as cosine similarity or Euclidean distance. As a particular example, the retrieval augmentation generation function 312 may compare the embeddings generated by the domain-specific tokenization function 310 for a user input 302 to embeddings of the unstructured text and related data 306 in order to identify which embeddings of the unstructured text and related data 306 appear most similar to the embeddings generated by the domain-specific tokenization function 310 for the user input 302. The retrieval augmentation generation function 312 can provide the extracted subset of information from the unstructured text and related data 306 to the large language model 308, which allows the large language model 308 to generate a proposed response to the user input 302 using (ideally) the most relevant information from the unstructured text and related data 306. The presence of the related data in the unstructured text and related data 306 allows the retrieval augmentation generation function 312 to use external knowledge (such as one or more taxonomies, ontologies, dictionaries, etc.) during operation. The retrieval augmentation generation function 312 includes any suitable logic configured to extract potentially-relevant information from unstructured text and related data.

In this example, an in-context learning (ICL) function 314 can be used to help one or both of the large language model 308 and the retrieval augmentation generation function 312 by providing additional information for use. For example, the in-context learning function 314 may identify examples of successful entity and relationship extractions from unstructured text and related data 306. The large language model 308 can use these successful examples as context in order to determine how (based on a current user input 302) entity and relationship extraction may be performed using the information extracted from the unstructured text and related data 306 by the retrieval augmentation generation function 312 for that user input 302. The retrieval augmentation generation function 312 can use these successful examples in order to learn how (based on a current user input 302) relevant information may be extracted from the unstructured text and related data 306. The in-context learning function 314 can use any suitable technique(s) to identify examples of successful entity and relationship extractions from unstructured text and related data 306. In some cases, the in-context learning function 314 may represent a machine learning model that has been trained using training samples, where the training samples include known good examples of successful entity and relationship extractions. The in-context learning function 314 includes any suitable logic configured to identify examples of successful entity and relationship extractions from unstructured text and related data 306.

In this particular example, the in-context learning function 314 may be trained using training data generated using a synthetic data generation (SDG) function 316. For example, the synthetic data generation function 316 may be used to generate training pairs, where each training pair includes an unstructured input text and one or more extracted entities and relationships identified using that unstructured input text. These training pairs can be used to train the in-context learning function 314 so that the in-context learning function 314 becomes effective at extracting successful entity and relationship extractions from the unstructured text and related data 306. The synthetic data generation function 316 can use any suitable technique to generate the training data. In some cases, for instance, the synthetic data generation function 316 may use a large language model (which may or may not represent the large language model 308) to identify entities and relationships associated with various (and potentially numerous) parts of the unstructured text and related data 306. This supports the use of synthetic training data that can be dynamically generated, such as by using a domain-specific vocabulary or ontology. The synthetic data generation function 316 includes any suitable logic configured to identify training data for entity and relationship extraction from unstructured text and related data 306.

As noted above, the large language model 308 can generate potential responses to user inputs 302. However, it is still possible that the large language model 308 may experience a hallucination and therefore generate an improper response to a user input 302. In this example, a retrieval-based grounding (RBG) function 318 can be used to help ensure that a proposed response to a user input 302 actually represents a valid response 304 that should be provided to a user. The retrieval-based grounding function 318 generally operates to ensure that any extracted entities or relationships identified by the large language model 308 actually exists in the unstructured text and related data 306. For example, the retrieval-based grounding function 318 may compare output tokens associated with a proposed response to tokens associated with the information extracted from the unstructured text and related data 306 by the retrieval augmentation generation function 312. If the tokens do not match or have adequate similarity (at least to within a specified threshold amount or percentage), it may be determined that the proposed response is not valid and should not be presented as a response 304. In this way, the retrieval-based grounding function 318 helps to mitigate hallucinations by ensuring that extracted entities and relationships actually exist. The retrieval-based grounding function 318 includes any suitable logic configured to compare tokens or other information to determine if hallucination may have occurred.

An additional technique may also be used to mitigate hallucinations by the large language model 308. A loss function 320 can be associated with the large language model 308 and used during training or fine-tuning of the large language model 308. The loss function 320 can be used to calculate a loss associated with the large language model 308 during training or fine-tuning, and the loss can be used to control how the large language model 308 or other components of the architecture are modified during the training or fine-tuning. For example, the loss function 320 can be used to calculate the loss value while the retrieval augmentation generation function 312 and the in-context learning function 314 are being used within the architecture 300. The loss function 320 can include terms associated with the retrieval augmentation generation function 312, the in-context learning function 314, the retrieval-based grounding function 318, and a hallucination mitigation function 322.

The hallucination mitigation function 322 can be used to identify instances where prompts or other inputs provided to the large language model 308 based on user inputs 302 contain concepts for which the large language model 308 has not been trained. For example, the hallucination mitigation function 322 may compare the embeddings generated based on the user inputs 302 to embeddings of training data used to train the large language model 308. During a fine-tuning process, the hallucination mitigation function 322 can modulate the loss function 320 through manipulation of the term in the loss function 320 associated with the hallucinations (referred to as [symbol] _{hallucination} below). By modulating this term in the loss function 320, the hallucination mitigation function 322 can help to train the large language model 308 to remain factual and reduce hallucinations.

In some embodiments, the loss function 320 can represent a custom loss function with multiple weighted terms to guide fine-tuning toward domain accuracy. The loss function 320 can also adapt dynamically using multiple sources of knowledge for specialized learning. As a result, the loss function 320 can incorporate domain-specific knowledge, grounding, hallucination correction, and retrieval-augmented learning. For example, the loss function 320 can support cosine similarity or other similarity for grounding, domain vocabulary weighting, hallucination detection, and dynamic retrieval-based fine-tuning.

Among other things, the loss function 320 can integrate multiple distinct strategies to support optimization techniques for LLM fine-tuning. These distinct strategies can include the following. A survey (done before fine-tuning) may be used to identify terms that are known or expected to be hallucination-prone, which can help to measure and weight hallucination risks in order to improve reliability in specialized domains. This may allow for pre-fine-tuning analysis in order to assign uncertainty scores to terms and integrate them into the loss function 320. The loss function 320 can also consider integrate real-time external knowledge sources (such as one or more taxonomies, dictionaries, or schemas) into the loss function 320 to support retrieval-augmented training for loss optimization. The loss function 320 can represent a mathematical function that combines multiple optimization techniques, thereby representing a composite loss function that integrates multiple measures of loss simultaneously. In addition, the loss function 320 can consider domain-specific tokenization as part of the loss calculation, which can integrate domain knowledge through one or more structured glossaries, taxonomy-based examples, fine-tuned weighting schemes, or other information.

In some cases, the loss function 320 may have the following form.

$${ℒ}_{custom} = \frac{1}{N} {\sum }_{i = 1}^{N} [ {λ}_{1} \cdot {ℒ}_{cosine} ( {G}_{i} , {R}_{i} ) + {λ}_{2} \cdot {ℒ}_{vocab} ( {G}_{i} ) + {λ}_{3} ( {h}_{t} ) \cdot {ℒ}_{hallucination} ( {G}_{i} ) + {λ}_{4} \cdot {ℒ}_{RAG} ( {G}_{i} , {D}_{i} ) + {λ}_{5} \cdot {ℒ}_{synthetic} ( {G}_{i} , {S}_{i} ) ]$$

Here, N represents a number of training inputs, Gᵢ represents a response generated by the large language model 308 for training input i, Rᵢ represents a desired or reference response (a ground truth) for training input i, Dᵢ represents a set of retrieved authoritative documents or other subset of information retrieved from the unstructured text and related data 306 for training input i, and Sᵢ represents a synthetic training example generated for training input i. Also, hₜ represents a hallucination penalty weight for term t, where term t represents a term from a vocabulary or from a hallucination-prone set of terms. Further, [symbol] _{cosine} represents a loss term that helps to ensure semantic similarity between the generated response Gᵢ and the reference response Rᵢ, [symbol] _{vocab} represents a loss term that encourages correct usage of domain-specific terminology, [symbol] _{hallucination} represents a loss term that penalizes responses including hallucination-prone terms, [symbol] _{RAG} represents a loss term that helps generated responses align with retrieved authoritative knowledge, and [symbol] _{synthetic} represents a loss term that helps to align the large language model's output with synthetically-generated in-context examples. In addition, λ₁, λ₂, λ₃, λ₄, and λ₅ represent weights applied to the different loss terms.

In order to help ensure semantic similarity between generated text and reference text, the following may be defined in some cases for the [symbol] _{cosine} loss term.

$${ℒ}_{cosine} ( {G}_{i} , {R}_{i} ) = 1 - \frac{{eG}_{i} \cdot {eR}_{i}}{‖ {eG}_{i} ‖ ‖ {eR}_{i} ‖}$$

Here, eGᵢ and eRᵢ respectively represent embedding vectors for the generated response Gᵢ and the reference response Rᵢ, ⋅ represents a dot product operator used for computing cosine similarity, and ∥⋅∥ represents a norm or magnitude of an embedding vector. In order to help encourage correct usage of domain-specific terminology, the following may be defined in some cases for the [symbol] _{vocab} loss term.

$${ℒ}_{vocab} ( {G}_{i} ) = {\sum }_{t ∈ V} {w}_{t} \cdot \text{?} ( t ∈ {G}_{i} )$$

Here, V represents a set of domain-specific terms, wₜ represents a weight assigned to each term t, and [symbol] (t∈Gᵢ) represents an indicator function that returns one if t appears in Gᵢ and zero otherwise. In order to penalize responses that include hallucination-prone terms, the following may be defined in some cases for the [symbol] _{hallucination} loss term.

$${ℒ}_{hallucination} ( {G}_{i} ) = {\sum }_{t ∈ H} {h}_{t} \cdot \text{?} ( t ∈ {G}_{i} )$$

Here, H represents the set of terms known or expected to be hallucination-prone (such as based on the pre-fine-tuning survey results), and hₜ represents the penalty weight assigned to each hallucination-prone term t. In order to help ensure that generated responses align with retrieved authoritative knowledge, the following may be defined in some cases for the [symbol] _{RAG} loss term.

$${ℒ}_{RAG} ( {G}_{i} , {D}_{i} ) = \frac{1}{\vert {D}_{i} \vert} {\sum }_{d ∈ {D}_{i}} ( 1 - \frac{{eG}_{i} \cdot ed}{‖ {eG}_{i} ‖ ‖ ed ‖} )$$

Here, Dᵢ represents the set of documents or other information retrieved by the retrieval augmentation generation function 312 for training input i, and ed represents an embedding vector of each specified document d. In order to help align the LLM's output with synthetically-generated in-context examples, the following may be defined in some cases for the [symbol] _{synthetic} loss term.

$${ℒ}_{synthetic} ( {G}_{i} , {S}_{i} ) = 1 - \frac{{eG}_{i} \cdot {eS}_{i}}{‖ {eG}_{i} ‖ ‖ {eS}_{i} ‖}$$

Here, eSᵢ represents an embedding vector for the synthetic training example Sᵢ generated for training input i.

Depending on the implementation, the loss function 320 may be used with various machine learning techniques in order to fine-tune the large language model 308. For example, the loss function 320 here may be used during “full model” fine-tuning in which all weights of a model could be updated or are at least able to be updated. However, this may be too computationally expensive or otherwise undesirable in some cases, such as for large LLMs. Thus, the loss function 320 here may also be used with partial model fine-tuning, such as parameter-efficient fine-tuning (PEFT) like low-rank adaptation (LoRA), in which certain LLM parameters are frozen and cannot be updated. In those cases, the loss function 320 may be applied while keeping some, many, or most of the model parameters frozen, which can be very useful for domain adaptation. As particular examples, when LoRA is used, fine-tuning may update only a subset of the attention layers of the large language model 308, and the loss function 320 can focus on guiding changes in attention-based knowledge representations. The hallucination penalty, cosine similarity loss, and RAG alignment described above could be used to influence only the LoRA-adapted layers. If full model fine-tuning is infeasible, embedding layers may be trained separately, and LoRA could be used for transformer layers to thereby help ensure that the loss function 320 still applies. If full model fine-tuning is performed, embedding layer updates can be performed using another technique, and LoRA may be used with the attention layers.

The survey mentioned above to identify terms known or expected to be hallucination-prone can be performed in any suitable manner. In some cases, the survey may occur as follows. Before fine-tuning, a survey can be conducted in which the large language model 308 is prompted with questions containing domain-specific terms, such as from one or more taxonomies, glossaries, or ontologies. For each term, multiple prompts can be generated to test the large language model's ability to recognize, define, and use the term correctly. The large language model's responses can be compared to gold-standard references (such as existing expert definitions or curated texts), and a hallucination score can be calculated for each term. In some cases, the hallucination score may be determined based on one or more cosine similarity scores (which may be calculated between generated LLM outputs and reference definition(s)), lexical and semantic accuracy (which may be calculated using domain-specific heuristics), agreement with retrieval-augmented knowledge (if applicable), and confidence metrics from the large language model 308 itself (which may be based on response entropy or log probability). Any term having a hallucination score exceeding a threshold can be identified as a hallucination-prone term. As described above, use of such terms in outputs generated by the large language model 308 can be penalized in the loss function 320, which helps to train or fine-tune the large language model 308 to avoid using hallucination-prone terms incorrectly. Among other things, this helps to guide the large language model 308 to be more cautious about uncertain terms, encourages grounding in external knowledge for high-risk terms, and prevents overconfidence in hallucinated definitions, and it allows the loss function 320 to be adjusted dynamically during training (instead of using a fixed penalty).

The domain-specific tokenization function 310, retrieval augmentation generation function 312, in-context learning function 314, and synthetic data generation function 316 can be used to help fine-tune the large language model 308 for use in at least one specialized domain. This is because these functions 310-316 can help to tailor the embeddings and other information provided to the large language model 308 for use in generating potential responses to user inputs 302. Moreover, the in-context learning function 314 and the synthetic data generation function 316 can help the retrieval augmentation generation function 312 to become more effective at identifying relevant information from the unstructured text and related data 306. The loss function 320 can also be used to help fine-tune the large language model 308 for use in at least one specified domain. In addition, the retrieval-based grounding function 318, the loss function 320, and the hallucination mitigation function 322 can be used to help to simultaneously discourage hallucinations by the large language model 308 and encourage output grounding. The resulting fine-tuned large language model 308 can represent a valuable asset in interacting with an enterprise or other organization's documents or other unstructured text 114 because the architecture 300 can be trained/fine-tuned based on that organization's domain-specific terms and concepts.

This type of approach can be used to more effectively fine-tune the large language model 308 for use in domains for which the large language model 308 was not trained and for which the large language model 308 may not recognize specialized terms. Moreover, this can be accomplished much faster and/or with significantly smaller amounts of processing and memory resources. For example, in some cases, the architecture 300 can be used to fine-tune a large language model 308 without needing large amounts of memory. As a particular example, using the described techniques, it is possible to fine-tune a large language model 308 using a conventional consumer-grade GPU, such as one having between sixteen and thirty-two gigabytes of memory. There is little or no need to use higher-grade GPUs, such as those containing more than ninety gigabytes of memory. As a result, the described techniques can provide significant resource and cost savings and enable faster fine-tuning, and result in models that use reduced computational resources (meaning lower resource requirements for training and inferencing operations).

Although FIG. 3 illustrates one example of an architecture 300 supporting LLM entity and relationship extraction for fine-tuning LLMs, various changes may be made to FIG. 3. For example, various components, operations, or functions in FIG. 3 may be combined, further subdivided, replicated, omitted, or rearranged and additional components, operations, or functions may be added according to particular needs.

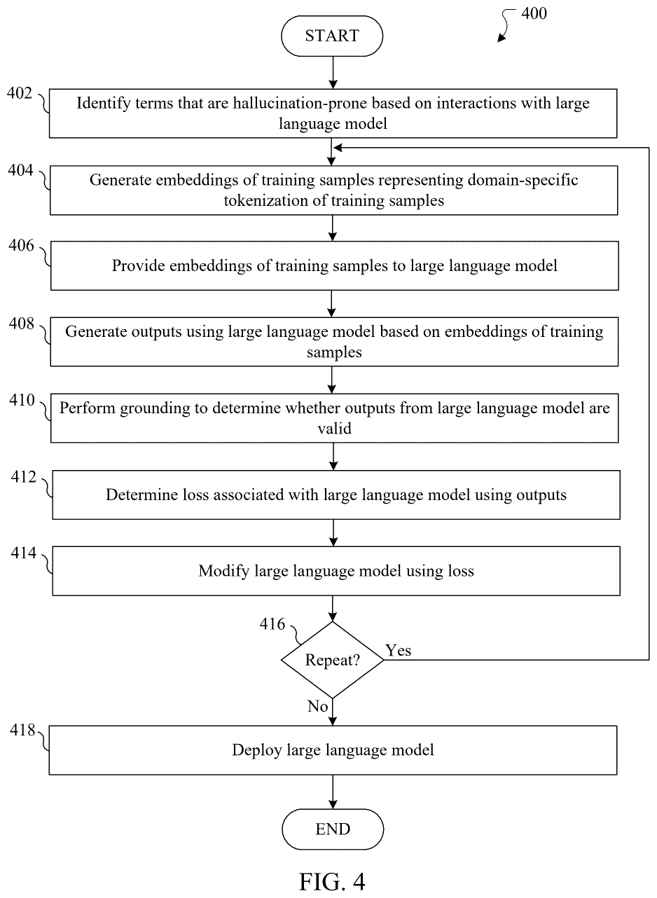

FIG. 4 illustrates an example method 400 for fine-tuning a large language model that operates in conjunction with retrieval augmentation generation and in-context learning according to this disclosure. For ease of explanation, the method 400 shown in FIG. 4 is described as being performed using the architecture 300 shown in FIG. 3 within the application server 106 in the system 100 shown in FIG. 1, where the application server 106 may be implemented using one or more instances of the device 200 shown in FIG. 2. However, the method 400 may be performed using any other suitable device(s) (such as a user device 102a-102d) and architecture(s) and in any other suitable system(s).

As shown in FIG. 4, terms that are hallucination-prone may be identified based on interactions with a large language model at step 402. This may include, for example, the processing device 202 of the application server 106 performing various interactions during a survey to calculate hallucination scores for terms used in unstructured text 114 or in unstructured text and related data 306. This may also include the processing device 202 of the application server 106 determining which terms have hallucination scores above a specified threshold. Note, however, that hallucination-prone terms may be identified in any other suitable manner.

Embeddings of training samples are generated at step 404. This may include, for example, the processing device 202 of the application server 106 performing the domain-specific tokenization function 310 to generate embeddings that represent a domain-specific tokenization of the training samples. The embeddings of the training samples are provided to the large language model at step 406. This may include, for example, the processing device 202 of the application server 106 providing the embeddings to a large language model 116, 308 along with other information. For instance, along with each training sample, the retrieval augmentation generation function 312 may provide a subset of information extracted from the unstructured text 114 or the unstructured text and related data 306 to the large language model 116, 308, where the extracted information appears most similar or otherwise appears relevant to the corresponding training sample. During this process, the in-context learning function 314 may optionally be used to provide examples of successful entity and relationship extractions from the unstructured text 114 or the unstructured text and related data 306, and the synthetic data generation function 316 may optionally be used to provide synthetic training examples of successful entity and relationship extractions based on the unstructured text 114 or the unstructured text and related data 306.

Outputs are generated using the large language model based on the embeddings of the training samples at step 408. This may include, for example, the processing device 202 of the application server 106 processing the embeddings of the training samples and the subsets of information extracted from the unstructured text 114 or the unstructured text and related data 306 using the large language model 116, 308. During this processing, the large language model 116, 308 can generate an output for each training sample by extracting one or more entities or one or more relationships from the information extracted from the unstructured text 114 or the unstructured text and related data 306 for that training sample. Grounding may optionally be performed to determine whether the outputs from the large language model are valid at step 410. This may include, for example, the processing device 202 of the application server 106 performing the retrieval-based grounding function 318 to determine whether the output generated by the large language model 116, 308 for each training sample is sufficiently similar to the information extracted from the unstructured text 114 or the unstructured text and related data 306 for that training sample.

A loss associated with the large language model is determined using the generated outputs at step 412. This may include, for example, the processing device 202 of the application server 106 using the loss function 320 to calculate a loss for the large language model 116, 308 based on the generated outputs, which can include comparing the generated outputs to corresponding ground truths (which represent expected or desired outputs of the large language model 116, 308). The loss here can be calculated using the loss function 320, which includes a loss term associated with hallucination mitigation. That loss term can be modulated during the fine-tuning of the large language model 116, 308 as a result of usage of terms that are hallucination-prone in the outputs generated by the large language model 116, 308. The loss function 320 may also include the other loss terms discussed above.

If necessary, the large language model is modified based on the loss at step 414. This may include, for example, the processing device 202 of the application server 106 modifying weights or other parameters of the large language model 116, 308 in order to try and reduce the differences between the generated outputs and the corresponding ground truths. If a determination is made to repeat another iteration of the training process at step 416, the process can return to step 404 to process the same training samples, different training samples, or both using the modified large language model 116, 308. At some point, training/fine-tuning of the large language model can be completed, and the large language model can be deployed for use at step 418. This may include, for example, the processing device 202 of the application server 106 placing the trained large language model 116, 308 and other components of the architecture 300 into use within the application server 106. This may also or alternatively include the processing device 202 of the application server 106 providing the trained large language model 116, 308 and other components of the architecture 300 to one or more other devices for use.

Although FIG. 4 illustrates one example of a method 400 for fine-tuning a large language model that operates in conjunction with retrieval augmentation generation and in-context learning, various changes may be made to FIG. 4. For example, while shown as a series of steps, various steps in FIG. 4 may overlap, occur in parallel, occur in a different order, or occur any number of times (including zero times).

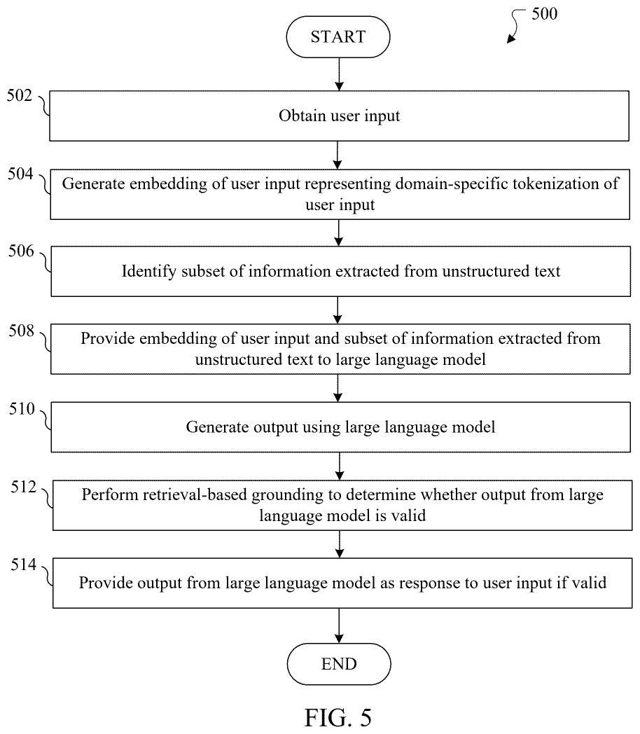

FIG. 5 illustrates an example method 500 for using a fine-tuned large language model that operates in conjunction with retrieval augmentation generation and in-context learning according to this disclosure. For ease of explanation, the method 500 shown in FIG. 5 is described as being performed using the architecture 300 shown in FIG. 3 within the application server 106 in the system 100 shown in FIG. 1, where the application server 106 may be implemented using one or more instances of the device 200 shown in FIG. 2. However, the method 500 may be performed using any other suitable device(s) (such as a user device 102a-102d) and architecture(s) and in any other suitable system(s).

As shown in FIG. 5, a user input is obtained at step 502. This may include, for example, the processing device 202 of the application server 106 receiving a user input 302 that includes a query, request, or other content from a user device 102a-102d. An embedding of the user input is generated at step 504. This may include, for example, the processing device 202 of the application server 106 performing the domain-specific tokenization function 310 to generate an embedding that represents a domain-specific tokenization of the user input 302.

A subset of information extracted from unstructured text is identified at step 506. This may include, for example, the processing device 202 of the application server 106 identifying a subset of information extracted from unstructured text 114 or unstructured text and related data 306 that appears most similar or otherwise appears relevant to the user input 302. During this process, the in-context learning function 314 may optionally be used to provide one or more examples of successful entity and relationship extractions from the unstructured text 114 or the unstructured text and related data 306, and the synthetic data generation function 316 may optionally be used to provide one or more synthetic training examples of successful entity and relationship extractions based on the unstructured text 114 or the unstructured text and related data 306.

The embedding of the user input and the extracted information are provided to the large language model at step 508. This may include, for example, the processing device 202 of the application server 106 providing the embedding and the extracted information to the large language model 116, 308. The large language model 116, 308 may have been trained (such as in the manner described above with respect to FIG. 4) using a loss that is based on at least a loss term associated with hallucination mitigation. That loss term may have been modulated during fine-tuning of the large language model 116, 308 as a result of usage of terms that are hallucination-prone in outputs generated by the large language model 116, 308 based on training samples.

An output is generated using the large language model at step 510. This may include, for example, the processing device 202 of the application server 106 processing the embedding of the user input 302 and the subset of information extracted from the unstructured text 114 or the unstructured text and related data 306 using the large language model 116, 308. During this processing, the large language model 116, 308 can extract one or more entities or one or more relationships from the information extracted from the unstructured text 114 or the unstructured text and related data 306, and the one or more entities or one or more relationships can be used to generate the output.

Grounding may optionally be performed to determine whether the output from the large language model is valid at step 512. This may include, for example, the processing device 202 of the application server 106 performing the retrieval-based grounding function 318 to determine whether the output generated by the large language model 116, 308 for the user input 302 is sufficiently similar to the information extracted from the unstructured text 114 or the unstructured text and related data 306. If so, the output from the large language model can be provided as a response to the user input or otherwise used to generate a response to the user input at step 514.

Although FIG. 5 illustrates one example of a method 500 for using a fine-tuned large language model that operates in conjunction with retrieval augmentation generation and in-context learning, various changes may be made to FIG. 5. For example, while shown as a series of steps, various steps in FIG. 5 may overlap, occur in parallel, occur in a different order, or occur any number of times (including zero times).

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for fine-tuning a large language model that operates in conjunction with retrieval augmentation generation and in-context learning, the method comprising:
providing embeddings of training samples to the large language model;
generating outputs using the large language model based on the embeddings of the training samples, wherein the large language model generates the outputs by extracting entities or relationships from unstructured text, the unstructured text provided as a result of the retrieval augmentation generation and the in-context learning;
determining a loss associated with the large language model using the outputs; and
modifying the large language model using the loss;
wherein the loss is based on a loss term associated with hallucination mitigation, the loss term associated with hallucination mitigation being modulated during the fine-tuning of the large language model as a result of usage of terms that are hallucination-prone in the outputs.

2. The method of claim 1, further comprising:
prior to providing the embeddings of the training samples to the large language model, identifying the terms that are hallucination-prone based on interactions with the large language model using the terms.

3. The method of claim 1, wherein:
the retrieval augmentation generation provides a subset of information extracted from the unstructured text for each training sample to the large language model;
the in-context learning provides examples of successful entity and relationship extractions from the unstructured text; and
the in-context learning is trained using synthetic data generation that creates synthetic training examples of successful entity and relationship extractions based on the unstructured text.

4. The method of claim 3, wherein the loss discourages hallucinations by the large language model and encourages proper grounding of the outputs generated by the large language model, the grounding provided by retrieval-based grounding that determines whether each response from the large language model is valid based on the associated subset of information extracted from the unstructured text.

5. The method of claim 4, wherein the retrieval augmentation generation, the in-context learning, and the retrieval-based grounding are performed using related data associated with the unstructured text, the related data providing context for entity or relationship extraction.

6. The method of claim 1, further comprising:
generating the embeddings of the training samples, the embeddings representing a domain-specific tokenization of the training samples.

7. The method of claim 1, wherein the loss associated with the large language model is determined using a loss function defined as:
$${ℒ}_{custom} = \frac{1}{N} {\sum }_{i = 1}^{N} [ {λ}_{1} \cdot {ℒ}_{cosine} ( {G}_{i} , {R}_{i} ) + {λ}_{2} \cdot {ℒ}_{vocab} ( {G}_{i} ) + {λ}_{3} ( {h}_{t} ) \cdot {ℒ}_{hallucination} ( {G}_{i} ) + {λ}_{4} \cdot {ℒ}_{RAG} ( {G}_{i} , {D}_{i} ) + {λ}_{5} \cdot {ℒ}_{synthetic} ( {G}_{i} , {S}_{i} ) ]$$
where: [symbol]
_{custom} represents the loss associated with the large language model;
N represents a number of the training samples;
Gᵢ represents a response generated by the large language model for a training input i;
Rᵢ represents a reference response for the training input i;
Dᵢ represents a subset of information retrieved from the unstructured text for the training input i, the subset of information associated with the retrieval augmentation generation;
Sᵢ represents a synthetic training example generated for the training input i, the synthetic training example associated with the in-context learning;
hₜ represents a hallucination penalty for a term t identified as being hallucination-prone; [symbol]
_{cosine} represents a loss term associated with semantic similarity between the generated response Gᵢ and the reference response Rᵢ; [symbol]
_{vocab} represents a loss term associated with correct usage of domain-specific terminology; [symbol]
_{hallucination} represents the loss term associated with hallucination mitigation and penalizes responses from the large language model that include the terms that are hallucination-prone; [symbol]
_{RAG} represents a loss term associated with the retrieval augmentation generation; [symbol]
_{synthetic} represents a loss term associated with the in-context learning; and
λ₁, λ₂, λ₃, λ₄, and λ₅ represent weights.

8. An apparatus for fine-tuning a large language model that operates in conjunction with retrieval augmentation generation and in-context learning, the apparatus comprising:
at least one processing device configured to:
provide embeddings of training samples to the large language model;
generate outputs using the large language model based on the embeddings of the training samples, wherein the large language model is configured to generate the outputs by extracting entities or relationships from unstructured text, the unstructured text based on the retrieval augmentation generation and the in-context learning;
determine a loss associated with the large language model using the outputs; and
modify the large language model using the loss;
wherein the loss is based on a loss term associated with hallucination mitigation, the at least one processing device configured to modulate the loss term associated with hallucination mitigation during the fine-tuning of the large language model as a result of usage of terms that are hallucination-prone in the outputs.

9. The apparatus of claim 8, wherein the at least one processing device is further configured, prior to providing the embeddings of the training samples to the large language model, to identify the terms that are hallucination-prone based on interactions with the large language model using the terms.

10. The apparatus of claim 8, wherein:
the at least one processing device is configured to perform the retrieval augmentation generation to provide a subset of information extracted from the unstructured text for each training sample to the large language model;
the at least one processing device is configured to perform the in-context learning to provide examples of successful entity and relationship extractions from the unstructured text; and
the at least one processing device is configured to train the in-context learning using synthetic data generation that creates synthetic training examples of successful entity and relationship extractions based on the unstructured text.

11. The apparatus of claim 10, wherein the loss discourages hallucinations by the large language model and encourages proper grounding of the outputs generated by the large language model, the at least one processing device configured to provide retrieval-based grounding to determine whether each response from the large language model is valid based on the associated subset of information extracted from the unstructured text.

12. The apparatus of claim 11, wherein the at least one processing device is configured to perform the retrieval augmentation generation, the in-context learning, and the retrieval-based grounding using related data associated with the unstructured text, the related data providing context for entity or relationship extraction.

13. The apparatus of claim 8, wherein the at least one processing device is further configured to generate the embeddings of the training samples, the embeddings representing a domain-specific tokenization of the training samples.

14. The apparatus of claim 8, wherein the at least one processing device is configured to determine the loss associated with the large language model using a loss function defined as:
$${ℒ}_{custom} = \frac{1}{N} {\sum }_{i = 1}^{N} [ {λ}_{1} \cdot {ℒ}_{cosine} ( {G}_{i} , {R}_{i} ) + {λ}_{2} \cdot {ℒ}_{vocab} ( {G}_{i} ) + {λ}_{3} ( {h}_{t} ) \cdot {ℒ}_{hallucination} ( {G}_{i} ) + {λ}_{4} \cdot {ℒ}_{RAG} ( {G}_{i} , {D}_{i} ) + {λ}_{5} \cdot {ℒ}_{synthetic} ( {G}_{i} , {S}_{i} ) ]$$
where: [symbol]
_{custom} represents the loss associated with the large language model;
N represents a number of the training samples;
Gᵢ represents a response generated by the large language model for a training input i;
Rᵢ represents a reference response for the training input i;
Dᵢ represents a subset of information retrieved from the unstructured text for the training input i, the subset of information associated with the retrieval augmentation generation;
Sᵢ represents a synthetic training example generated for the training input i, the synthetic training example associated with the in-context learning;
hₜ represents a hallucination penalty for a term t identified as being hallucination-prone; [symbol]
_{cosine} represents a loss term associated with semantic similarity between the generated response Gᵢ and the reference response Rᵢ; [symbol]
_{vocab} represents a loss term associated with correct usage of domain-specific terminology; [symbol]
_{hallucination} represents the loss term associated with hallucination mitigation and penalizes responses from the large language model that include the terms that are hallucination-prone; [symbol]
_{RAG} represents a loss term associated with the retrieval augmentation generation; [symbol]
_{synthetic} represents a loss term associated with the in-context learning; and
λ₁, λ₂, λ₃, λ₄, and λ₅ represent weights.

15. A method for using a fine-tuned large language model that operates in conjunction with retrieval augmentation generation and in-context learning, the method comprising:
obtaining a user input;
generating an embedding of the user input;
providing the embedding of the user input and a subset of information extracted from unstructured text to the large language model, the subset of information extracted from the unstructured text provided as a result of the retrieval augmentation generation and the in-context learning; and
generating an output using the large language model, wherein the large language model generates the output by extracting one or more entities or one or more relationships from the subset of information extracted from the unstructured text;
wherein the large language model is trained using a loss that is based on a loss term associated with hallucination mitigation, the loss term associated with hallucination mitigation being modulated during fine-tuning of the large language model as a result of usage of terms that are hallucination-prone in outputs generated by the large language model based on training samples.

16. The method of claim 15, wherein the embedding of the user input represents a domain-specific tokenization of the user input.

17. The method of claim 15, wherein:
the retrieval augmentation generation provides the subset of information extracted from the unstructured text for the user input to the large language model;
the in-context learning provides examples of successful entity and relationship extractions from the unstructured text; and
the in-context learning is trained using synthetic data generation that creates synthetic training examples of successful entity and relationship extractions based on the unstructured text.

18. The method of claim 15, further comprising:
performing retrieval-based grounding that determines whether the response from the large language model is valid based on the subset of information extracted from the unstructured text;
wherein the loss discourages hallucinations by the large language model and encourages proper grounding.

19. The method of claim 18, wherein the retrieval augmentation generation, the in-context learning, and the retrieval-based grounding are performed using related data associated with the unstructured text, the related data providing context for entity or relationship extraction.

20. The method of claim 15, wherein the loss associated with the large language model is determined using a loss function defined as:
$${ℒ}_{custom} = \frac{1}{N} {\sum }_{i = 1}^{N} [ {λ}_{1} \cdot {ℒ}_{cosine} ( {G}_{i} , {R}_{i} ) + {λ}_{2} \cdot {ℒ}_{vocab} ( {G}_{i} ) + {λ}_{3} ( {h}_{t} ) \cdot {ℒ}_{hallucination} ( {G}_{i} ) + {λ}_{4} \cdot {ℒ}_{RAG} ( {G}_{i} , {D}_{i} ) + {λ}_{5} \cdot {ℒ}_{synthetic} ( {G}_{i} , {S}_{i} ) ]$$
where: [symbol]
_{custom} represents the loss associated with the large language model;
N represents a number of the training samples;
Gᵢ represents a response generated by the large language model for a training input i;
Rᵢ represents a reference response for the training input i;
Dᵢ represents a subset of information retrieved from the unstructured text for the training input i, the subset of information associated with the retrieval augmentation generation;
Sᵢ represents a synthetic training example generated for the training input i, the synthetic training example associated with the in-context learning;
hₜ represents a hallucination penalty for a term t identified as being hallucination-prone; [symbol]
_{cosine} represents a loss term associated with semantic similarity between the generated response Gᵢ and the reference response Rᵢ; [symbol]
_{vocab} represents a loss term associated with correct usage of domain-specific terminology; [symbol]
_{hallucination} represents the loss term associated with hallucination mitigation and penalizes responses from the large language model that include the terms that are hallucination-prone; [symbol]
_{RAG} represents a loss term associated with the retrieval augmentation generation; [symbol]
_{synthetic} represents a loss term associated with the in-context learning; and
λ₁, λ₂, λ₃, λ₄, and λ₅ represent weights.
